(19) United States
(12) Patent Application Publication
(10) Pub. No.: US 2025/0368495 A1
(43) Pub. Date: Dec. 4, 2025

(54) SYSTEM AND METHOD FOR AUTOMATED DISPENSING OF BEVERAGES IN REUSABLE UNITS

(71) Applicant: Tricopian, Inc., Del Mar, CA (US)

(72) Inventor: Chi W. Yau, Escondido, CA (US)

(21) Appl. No.: 19/226,018

(22) Filed: Jun. 2, 2025

Related U.S. Application Data
(60) Provisional application No. 63/655,520, filed on Jun. 3, 2024.

(51) Int. Cl. B67D 1/08; G07F 15/06

(52) U.S. Cl. CPC B67D 1/0888; B67D 1/0801; G07F 15/06; B67D 2001/0811

(57) ABSTRACT

An automated dispensing system that is able to automatically dispensing beverages into reusable or recyclable products. The refillable beverage dispenser is a convenient and environmentally friendly automated system that is able to determine previous refill preferences of a user saved from a user profile. The automated dispensing system is also able to determine if the user has any refills available credited on their account to expediate the refillable dispensing process facilitating a hand-free experience.

### BACKGROUND

This disclosure relates to the field of vending, and particularly to the field of automated vending of beverages into reusable or recyclable products. Refillable beverage dispensers are a convenient and environmentally friendly way to serve drinks at events, gatherings, or in commercial settings, offering easy access to refreshing beverages while minimizing waste from single-use containers. Furthermore, a refillable or reusable unit further minimizes the waste of having multiple single-use containers. Refillable containers come in various shapes, sizes, and materials, offering a sustainable alternative to single-use packaging.

### BRIEF DESCRIPTION OF THE DRAWINGS

FIG. 1 depicts an embodiment of a system for automated dispensing beverages in reusable units.

FIG. 2 depicts a method for a subscription automated beverage dispensing in reusable units.

FIG. 3 depicts a method for user verification in automated beverage dispensing.

FIG. 4 depicts a method for automated dispensing of beverages in reusable units.

FIG. 5 depicts a method for registration for an automated beverage dispensing service.

### SUMMARY

In one aspect described herein, an automated dispensing system comprises a scanner, a dispensing mechanism, and a user interface configured to: receive a refillable unit; using the scanner, identify an electronic identifier of the refillable unit, wherein the electronic identifier is within electronic range of the dispensing mechanism; verify the electronic identifier; and in response to a positive verification of the electronic identifier, automatically dispense a refill selected by a user.

In some embodiments, a user inserts a refillable unit in the automated dispensing system and selects a beverage to be filled into the refillable unit.

In some embodiments, the refillable unit is associated with a user subscription, and wherein the user subscription provides active payment data for a user, user preference selections, wherein user preference selections may include beverage temperature of the refill, additional flavors, ratio of ice to beverage user account data, subscription status data, and/or metadata associated with the user subscription.

In some embodiments, when the user interface is further configured to upon determining that the electronic identifier does not correspond to a valid user subscription, decline a request for dispensing a desired refill.

In some embodiments, the dispensing system dispenses at least one of the following into the refillable unit: a cosmetic substance, a food substance, a beverage, or an electronic device.

In some embodiments, the scanner maintains a count of refills associated with the refillable unit, and wherein the user interface displays an error in response to a refill request if the count of refills passes a refill threshold.

In some embodiments, the user when establishing their subscription associated with the refillable unit can input user preferences of a preferred beverage and the scanner when scanning the electronic identifier automatically dispenses a requested refill preference.

In some embodiments, the dispensing mechanism is further configured to dispense an attachable electronic identifier configured to be affixed to the removable unit.

In some embodiments, the user interface is further configured to receive one or more characteristics of the refillable unit, and to associate the one or more characteristics with the attachable electronic identifier.

In another aspect, an automated dispensing system for comprises receiving a refillable unit; receiving, at a scanner, an electronic signal of an embedded electronic identifier of the refillable unit, wherein the electronic signal identifies a user profile associated with the refillable unit; validating, via a server, the user profile, wherein validating the user profile comprises determining whether the user profile is authorized for a prepaid refill; upon determining authorization for the prepaid refill, refilling the refillable unit; upon determining no prepaid refills remain in connection with the user profile, prompting a user for a payment method.

In some embodiments, refilling the refillable unit comprises determining a previous refill of the user profile; and confirming, via a user interface, whether the previous refill preference should be repeated, wherein a previous refill preference may include a refill temperature, additional flavors, or ice ratio.

In some embodiments, upon processing data from the user profile, a user interface provides a prompt to a user that suggests a new refill product the user may prefer based on previous selections.

In some embodiments, the scanner maintains a count of refills associated with the refillable unit, and wherein a user interface displays an error in response to a refill request if the count of refills passes a refill threshold.

In some embodiments, the refillable unit is associated with a prepaid refill value or a recurring subscription charge for a given refill count.

In another aspect, a method of automatically refilling a refillable unit comprises receiving a refillable unit in an automated dispensing system, wherein the refillable unit is associated with an electronic identifier; inputting user information from a user profile associated with the refillable unit; determining a prepaid refill remains; upon determining a prepaid refill remains, refilling the refillable unit refilled with desired contents based on the user profile; and if there are no prepaid refills left on the user profile associated with the refillable unit, being prompted to input a payment method and then having the refillable unit refilled with a desired refill associated with the user profile.

In some embodiments, upon determining that the electronic identifier does not correspond to a valid user subscription, declining a request for dispensing a desired refill.

In some embodiments, the desired refill the user has previously inputted is saved on the user profile along with any preferred additions including a refill temperature, additional flavor, or ice ratio.

In some embodiments, the electronic identifier maintains a count of refills associated with the refillable unit.

In some embodiments, the refillable unit is associated with a prepaid refill value or a recurring subscription charge for a given refill count.

In some embodiments, the method further comprises dispensing an attachable electronic identifier configured to be affixed to the removable unit.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description and drawings are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

Many establishments provide beverages from a dispenser, such as a fountain or filling station (e.g., gas stations, restaurants, amusement parks, etc). Some provide reusable cups, mugs, bottles, containers, and the like (hereafter “refillable units”). In traditional solutions, a user may fill the reusable cup and approach the counter to pay for the beverage. However, in such an example, the establishment cannot verify that the user is the purchaser of the refillable unit or if one refillable unit is being shared by several users, thus impacting overall cost of operation and undercutting sales. Other establishments may have a subscription service for beverages tied to the identity of the user (e.g., through a phone number). For example, a user may fill a refillable unit and input a phone number at checkout. Such subscription services may result in various issues of waste and extra cost. For example, if a beverage is dispensed and then no valid subscription is provided at checkout, the beverage may be wasted or must be paid for separately.

Additionally, many establishments provide other edible foods that can be dispensed into refillable units. Such edible foods can be in solid, liquid, and/or granular forms including cereals, soups, coffee beans, snacks, nonperishables, and various toppings for such, as well as paste forms such as creams and yogurts. The refillable unit for such containers may be in the shape of a bowl or cup or a varying configuration to hold such edible materials that they user may desire.

In systems and methods described herein, the challenges discussed above that are faced by traditional dispensing solutions, among others, are addressed. In the systems and methods disclosed herein, a refillable unit includes an integrated or embedded electronic identifier which is recognizable by the refilling station prior to allowing dispensing of beverages. The embedded electronic identifier allows a user's subscription to be verified prior to dispensing the beverage, and the beverage can be paid for via the identified subscription without the need for the user to checkout or interact with a cashier or employee of the establishment. This allows for an establishment or entity to provide self-service refillable beverage stations without needing an employee to be in constant attendance. In some embodiments, the electronic identifier may be separately attached to the refillable unit, for example, by a refilling station or a user.

Further, a refillable unit may, if desired by the establishment, be tied to a single entity (e.g., a gas station, a mall, an airport). In such an example, the refillable unit may be only usable at that identified establishment or location, or at similar locations owned by the same organization and operated by the entity providing the refillable unit. If the user is near a different establishment that is operated by a different entity than the provider of the refillable unit, the user may be required to get a separate refillable unit. Thus, a user may have to keep track of a number of separate refillable units for different entities.

In some examples, upon identification and successful verification of a user through an embedded electronic identifier in connection with a refillable unit, substances other than beverages may be dispensed. For example, a user may provide a refillable cosmetic or makeup container to the dispensing mechanism and receive back the cosmetic container with new makeup, skincare, or cosmetics (e.g., liquid foundation, lip glosses and lipstick, moisturizers, creams, shadows, blushes, mascaras, etc.). In this way, a user may receive automatic refills on cosmetic materials while recycling the containers they have already purchased, thus reducing waste and cost for the consumer. In some examples, the dispensing mechanism may provide a discount to a user on a product such as cosmetics or skincare as an incentive to recycle and reuse containers.

In another example, the dispensing mechanism may provide customized beverages and flavors or carbonation to still beverages. In still other examples, the dispensing mechanism may provide food substances rather than beverages. For example, the dispensing mechanism may be provided by a grocery store to automate certain processes and reduce waste: a user may provide reusable cans or jars for certain food products and receive refilled containers in return from the dispensing mechanism. For example, a user may refill jams, cheeses, breads, meats, vegetables, fruits, or pickled items in reusable containers from the dispensing mechanism.

In another example, the dispensing mechanism may provide an automated mechanism to track how many refills are occurring with any given user. For example, cameras or automated weight sensing mechanisms may be connected to algorithms of the dispensing mechanism in order to track if a user refills a given unit beyond a set threshold of refills that may be allotted to a single user. In this way, the dispensing mechanism may protect against misuse of the refill machine without requiring employee management or assistance.

Systems and methods described herein provide the possibility of a nationwide or universal refillable beverage that can be used at any establishment that uses the subscription service such that a user need only have a single refillable unit. The user can use the refillable unit at many different places, in many different locations.

The following description of the figures describes in further detail embodiments of systems and methods for automated beverage dispensing.

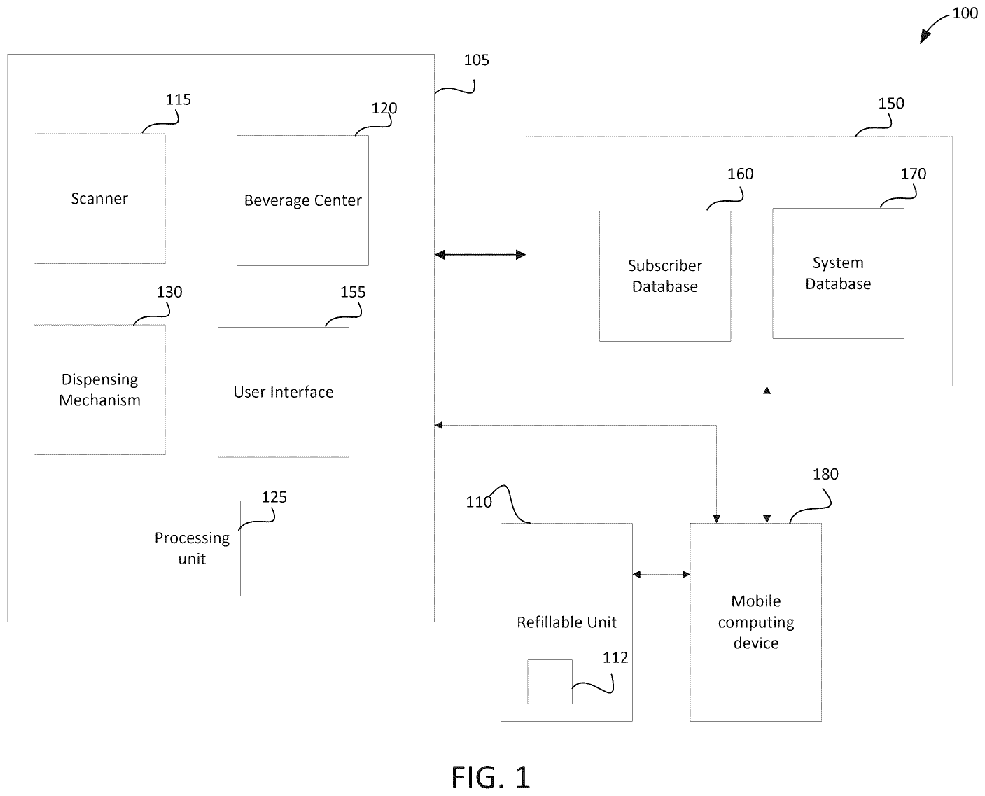

FIG. 1 is a diagram of an exemplary system for the maintenance and method of usage of automated dispensing of beverages in refillable units. The automated dispensing system 100 includes a station 105, a refillable unit 110, a server 150, and a mobile computing device 180. A refillable unit 110 is used in conjunction with the station 105 and the server 150. The refillable unit 110 can be designed for holding cold beverages or for holding hot beverages. The refillable unit 110 can also be designed to hold other solid and granular forms of edible materials such as cereals, coffee beans, creams, and yogurts. In some embodiments, the refillable unit 110 is an insulated container suitable for hot or cold beverages. In some embodiments, the refillable unit 110 may be specifically designed to hold only either hot or cold beverages. The refillable unit 110 can be made of a variety of materials including but not limited to plastic, glass, aluminum, etc. and capable of holding a variety of volumes of liquid depending on the type of beverage a user desires. In some embodiments, the refillable units 110 may have a handle or other carrying mechanism to facilitate transportation and handing of the dispenser. In some embodiments, the refillable unit 110 is designed, sized, and/or shaped to fit into a corresponding space, slot, or areas of the station 105.

The refillable unit 110 includes an identifier 112. The identifier 112 can be a computer readable code on the refillable unit, such as a 1D or 2D barcode, or QR code. In some embodiments, the identifier 112 can be an RFID tag on or embedded in the refillable unit 110. In some embodiments, the identifier 112 can be a Bluetooth® low energy circuit or other or other similar device to enable identification and/or communication with the station 105 and server 150. In some embodiments, the identifier 112 can contain information of the refillable unit 110 such as material information so that the refillable unit 110 may be automatically sorted during a recycling process. The identifier 112 can encode a user's subscription information and refillable unit information as well as a wealth of information associated with the identifier 112 and stored online in the server 150. The subscription information can be encoded in the identifier 112 or can be associated with the identifier 112 as will be described below. The subscription information can include payment information, usage information, for example, how many beverages per day are available, purchase times, etc., and user information, for example, user identity, user home location, etc. The refillable unit information can include a unique serial number which uniquely identifies the refillable unit 110 to the station 105 and the server 150. In some embodiments, the refillable unit information includes a unit type identifier. The unit type identifier can identify the type of refillable unit 110, for example, hot beverage container, cold beverage container, insulated container, etc. By identifying the type of container and using the subscription information, the station 105 can dispense only beverages approved or intended for use in the specific type of container, or only types of beverages which are part of the subscription. Additionally, other information associated with the identifier 112 that correlates to the refillable unit 110 can include container information such as the capacity and volume of the container, whether the container is insulated, the security that the container provides with the materials dispensed within, and whether the material trying to be dispensed within a particular container would be safe. For example, if the container is a milk bottle, the station 105 will not dispense an oil into it.

In some embodiments, the refillable unit 110 can originate with the user, and a separable identifier 112 can be attached thereto. The identifier 112 can have an adhesive to adhere to a user-provided refillable unit 110, or can otherwise be removably attached or non-removably attached to a refillable unit 100. The identifier can be associated with properties of the refillable unit 110, such as size, capacity, construction material, and the like, as described elsewhere herein.

The station 105 is a beverage filling station, such as a soda fountain or similar system having one or more options for beverages to be dispensed. The beverages can be, for example, soft drinks, hot drinks such as hot cocoa, coffee, or tea, beer, wine, etc. The station can be unmanned, where an employee is not required as part of the transaction. The station 105 may further comprise a refillable unit 110 purchasing module (not shown) which dispenses refillable units 110, or identifiers 112 to be affixed to refillable units 110.

The station includes a scanner 115, a beverage center 120, a dispensing mechanism 130, a user interface 155, and a processing unit 125.

The station 105 is under control of the processing unit 125. The processing unit 125 can comprise one or more processors, one or more memories, and communication and data lines. The processing unit 125 controls communication and operations of the station 105, and communicates with the server 150. In some embodiments, the processing unit 125 includes a communication feature which enables wireless communication, such as over a cellular network, NFC, phone-as-token, or Bluetooth® communication with the mobile computing device 180, which will be described in greater detail elsewhere herein.

The scanner 115 can be an optical scanner, an RF reader, a Bluetooth® circuit, or any combination thereof. The scanner 115 emits a signal, such as an interrogation signal or an
optical reading signal to read the identifier 112. In some embodiments, the scanner 115 receives a signal emitted from the identifier 112. The scanner 115 communicates the identifier 112 to the processing unit 125 and communicates the identifier to the server 150 directly or via the processing unit 125.

The beverage center 120 holds one or more beverages for dispensing. The beverage center 120 can hold both cold and hot beverages and one or more outlets for dispensing beverages into the refillable units 110. The beverage center can have a slot, area, or compartment configured to receive the refillable unit 110 therein. In some embodiments, the scanner 115 can be located in or proximate to the beverage center such that the scanner 115 can read the unique identifier 112 when the refillable unit 110 is inserted into the beverage center 120. In some embodiments, the beverage center 120 may hold refillable units for dispensing. In some embodiments, the dispensing mechanism 130 may also dispense refillable units 110 which have integrated or embedded identifiers 112. The beverage center may hold one or more types of containers with one or more outlets for dispensing refillable units 110.

The dispensing mechanism 130 is connected to the beverage center 120 and is in communication with the processing unit 125. The dispensing mechanism 130 comprises one or more valves in the outlet of the beverage center, and facilitates or controls the dispensing of beverages. The dispensing mechanism 130 is closed, or prevents the flow of beverages until the processing unit 125 sends a signal to the dispensing mechanism 130 to dispense a beverage. This process will be described in greater detail below.

The user interface 155 allows a user to interact with the automated dispensing system
100. The user interface 155 may be embodied with a graphical interface, a touch screen, soft keys or buttons, and the like. In some embodiments, the user interface 155 is the point of contact with the station 105. The user interface 155 may include varying options for the user to input information about the refillable unit 110. In some embodiments, the user interface 155 may provide instructions for scanning the identifier 112 on the refillable unit 110 presented for filling. In some embodiments, the user interface 155 may receive a request to refill a refillable unit 110 or may receive a request for dispensing a refillable unit 110 and subscribing options. In some embodiments, the user interface 155 may be accessed on the mobile computing device 180 as part of an application or other program, that users are able to use to operate the station 105. The user interface 155 interacts with the station 105 and signals the user's requests for beverages to the processing unit 125 and the beverage center 120. In some embodiments the user interface 155 can be both physically located on the station 105, and on a mobile computing application where the same, different, or complementary functions are available to the user. In some embodiments, for example, where the user requests an identifier 112 to adhere to a user-provided refillable unit 110, the user can provide, via the user interface 155, properties or characteristics of the user-provided refillable unit 110. The system 100 can associate the requested identifier 112 when the properties or characteristics of the user-provided refillable unit have been provided, and they can be associated with the identifier 112 and the user's subscription or account information. In some embodiments, the station 105 may not have a user interface 155, for example, where the user mobile computing device 180 can provide the user interface 155 the same function alternatively or in combination with the user interface 155.

The station 105 is in wired or wireless communication with the server 150. The server may be located at or near the station 105. In some embodiments, the server 150 is located remote from the station 105. In some embodiments, the server 150 may comprise one or more memories and one or more processors and communication circuits to provide communication to and receive communication from the station 105.

The server 150 comprises or is in communication with a subscriber database 160 and a system database 170. The subscriber database 160 stores subscription information for users of the automated dispensing system 100. The subscription information includes, for example, subscription details, such as number and type of drinks per day, week, etc. names, phone numbers, email addresses, physical address, payment information of users. The subscription information further includes the identifier 112 of the refillable unit 110 associated with the user. In some embodiments the subscription information includes a user profile with beverage preferences, home locations, customized drinks, past orders, etc. In some embodiments, profile information can be input via the user interface 155. In some embodiments, the station 105 can provide suggestions for future drinks based on a user's preference information.

The processing unit 125 is configured to receive verification, confirmation, or instruction from the server 150 based on the identifier 112 and the subscription information in the subscriber database 160 prior to dispensing the beverage.

The system database 170 comprises a list of refillable units 110 and identifiers 112 that have been sold, purchased, vended, etc. The system database 170 includes descriptions and information regarding types of refillable units 110 and the identifiers 112. The system database 170 may include the location of the stations 105 throughout a geographic area, such as in a county, state, country, etc. The location can be geographic coordinates and can include a geofence for each station 105. In some embodiments, the user interface can alert a subscriber when the subscriber is within a geofence of one or more stations 105.

When a user inserts the refillable unit 110 into the station 105, the user can also opt to exchange the refillable unit 110 with a different refillable unit 110 from the station 105. The user may opt to swap the refillable unit 110 if the refillable unit 110 need to be recycled, or the user would like a different refillable unit 110 for a different beverage or edible material of their choice. The refillable unit 110 can be returned for a trade-in, replacement, or recycle option. If the user decides to recycle the refillable unit 110, the user may receive a credit on their account for a purchase of a different refillable unit 110.

When a user does not have a refillable unit 110 and has an active subscription, the user may opt to register their own container or request dispensing of a refillable unit 110. The material, size, etc. of the user-originated reusable unit would be inputted into the system database via the server 150 and/or user interface 155. An identifier 112 may be printed out or dispensed at the station 105 and affixed to the user-originated refillable unit.

The user may also opt to purchase a one-time-use unit if they already have an active subscription. This one-time-use unit may have an identifier 112 that prohibits the ability of the dispensing mechanism 130 to refill. If the user has a limited number of drinks on their subscription, this one-time-use unit would count as one. The subscription may also limit the number of one-time-use units available to each user. The one-time-use unit may be returned to be recycled.

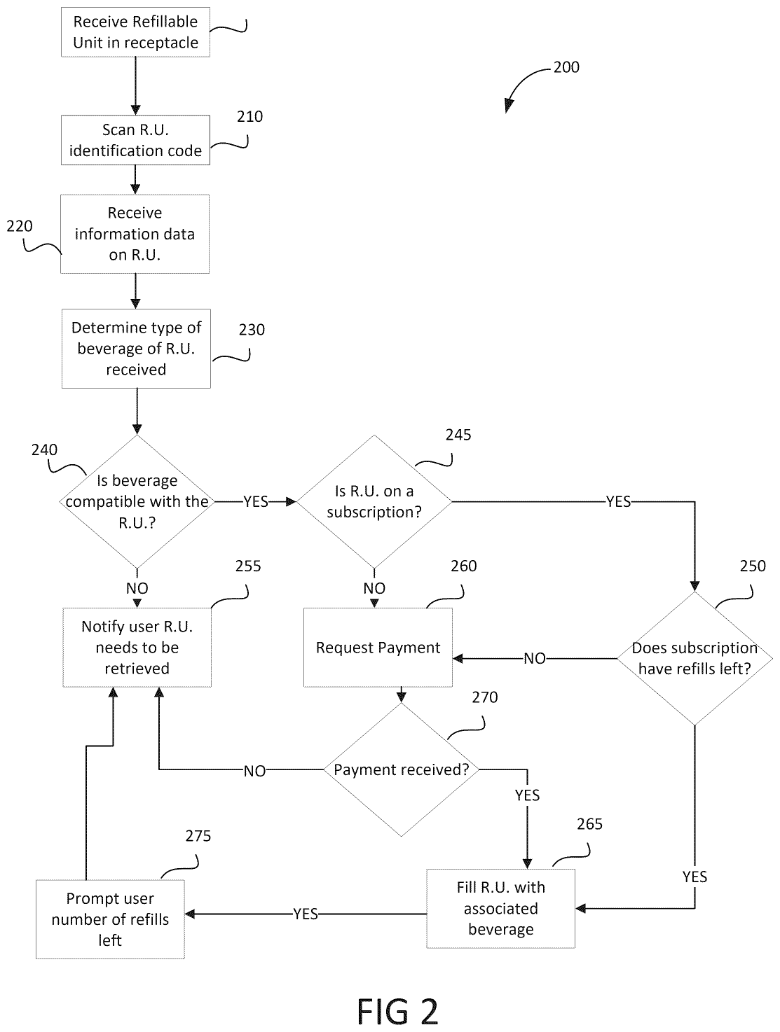

FIG. 2 is a flow chart illustrating an exemplary process for the method of using an automated dispensing system of beverages with a refillable unit 110. A process 200 begins at block 205 wherein station 105 receives refillable unit 110. Receiving the refillable unit can also include receiving in the user interface 155 a request for of selection of a specific beverage. The process 200 moves to block 210 wherein the scanner 115 scans the refillable unit
110. The scanner 115 reads the identifier on the refillable unit 110. The scanner 115 can read the identifier 112 and interpret the identifier. In some embodiments, the scanner 115 communicates the read information to the processing unit 125.

The process 200 moves to block 220 wherein the server 150 receives the identifier 112 of the refillable unit 110 based on information received from the scanner 115. The identifier 112 can include the information described elsewhere herein. The scanner 115 and/or the processing unit 125 can send the read identifier 112 to the server 150. In some embodiments, the scanner 115 and/or the processing unit 125 sends information indicative of the read identifier, such as decoded or decrypted information, to the server 150.

The process 200 moves to block 230 where the server 150 interprets the received read identifier 112 or the information indicative thereof. The server 150 determines the type of the refillable unit 110 based on the received identifier 112. The server can communicate the type of the refillable unit 110 to the station 105 so that only beverages appropriate for the type of the refillable unit 110 are dispensed. The type of refillable unit 110 may indicate the material, shape, and size of the refillable unit 110. For example, if the identifier 112 identifies the refillable unit as an insulated container, then the automated dispensing system 100 will know that the refillable unit 110 can safely receive a hot beverage. If the refillable unit 110 is of a plastic material, then the automated dispensing system 100 may not dispense a hot beverage. Additionally, if the refillable unit 110 received can only hold 12 fl. oz. then the amount dispensed will not exceed 12 fl. oz. When the user receives the refillable unit 110 with the unique identifiable code on it, the code associated will be programmed with the type of container the refillable unit 110 is.

The process 200 from block 230 moves to decision state 240. At decision state 240 the server 150 determines if the beverage requested is compatible with the refillable unit 110 is available and/or if the beverage is available.

If in decision state 240 the server determines that a compatible beverage is not in stock, or that the requested beverage is not available, then the process 200 moves to block 255 where the user interface 155 notifies the user that the refillable unit 110 cannot be filled, and the process ends.

If at decision state 240 the server determines that the requested beverage is compatible with the refillable unit 110, or the types of beverages compatible with the refillable unit 110 are in stock, then the process moves to decision state 245 to determine whether the refillable unit has a subscription that is associated with it. It will be understood that this decision state, and other decision states described herein can be rearranged or reordered with in the methods described, or can be omitted.

In decision state 245, the server 150 queries the subscriber database 160 using the received identifier using the information stored in the user database to determine whether the refillable unit 110 has a subscription associated therewith. At decision state 245 the server 150 determines whether the user has a subscription.

If the server 150 determines in decision state 245 that there is no subscription associated with the identifier of the refillable unit 110, the process moves to block 260, wherein the user interface 155 requests a payment for a beverage. If the payment is not received, the process 200 moves to block 255, where the user interface 155 informs the user that the transaction cannot be completed, and the process ends.

If the server 150 determines there is a subscription associated with the refillable unit 110, then the process 200 moves to decision state 250 where the server 150 checks the subscription details to determine whether the subscription is current, whether there are refills available to dispense based on the terms of the subscription associated with the refillable unit 110, whether the requested beverage is dispensable based on the terms of the subscription, whether the subscription is active and paid-up, and the like. For example, the user may be paying for a weekly, monthly, yearly, or other predetermined amount of time recurring subscription. The user may have a set number of refills based on the subscription plan.

If the server 150 determines that the user's subscription supports the beverage request, the process 200 next moves to block 265. At block 265 the server 150 communicates authorization to the station 105 to fulfill the request received via the user interface 155. For example, the server 150 instructs the processing unit 125 that the requested beverage is appropriate for the refillable unit 110, that the requested beverage is within the terms of the subscription associated with the refillable unit 110, and that the requested beverage is in stock. The processing unit then instructs the dispensing mechanism 130 to dispense the requested beverage in the correct amount into the refillable unit 110 in the beverage center 120.

The process 200 moves to block 275 where the user interface 155 displays the number of refills left in their subscription or any other useful subscription information.

The process 200 moves to block 255, where the user interface 155 prompts removal of the refillable unit 110 and the process ends.

Returning to decision state 250, if, the server 150 determines that the subscription does not have any refills left, that the requested beverage is not within the terms of the subscription, or that the requested beverage cannot be dispensed for other subscription related reasons, the process 200 moves to block 260 where payment is requested to cover the refill.

The process 200 moves to decision state 270, wherein the the server 150 determines that the payment has been received. If payment has been received, the process 200 moves to block 285 where the automated dispensing system fills the refillable unit 110 with the user's selected beverage, and the process proceeds as described above.

In some embodiments, when the refillable unit 110 is inserted into the station 105 and the scanner 115 reads the identifier 112 as described above, the server can query the subscription information in the subscriber database. The subscriber database 160 may contain a preference for a standard requested beverage or a default beverage associated with the identifier 112. In this case, the server 150 can communicate the standard beverage to the processing unit 125, and the processing unit will automatically dispense the standard beverage listed in the subscriber preferences without any input via the user interface 155.

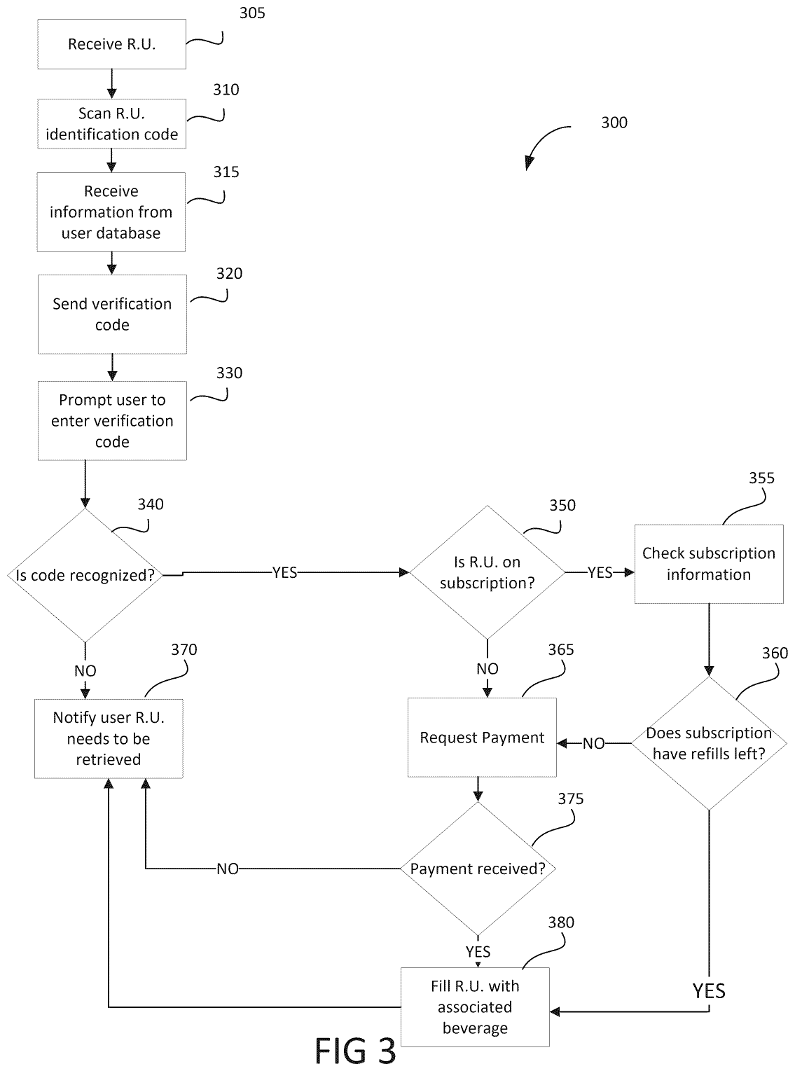

FIG. 3 is a flow chart illustrating a method of using an automated dispensing system with a refillable unit 110. A process 300 begins at block 305 wherein the automated dispensing system 100 receives a refillable unit 110 and a request to dispense a beverage.

The process 300 moves to block 310 where the scanner 115 scans the refillable unit 110 with identifier 112 that is on or associated with the refillable unit 110. The identification code can either be on the refillable unit 110 itself or provided by the user via the user interface 155. This process can be similar to those described with regard to process 200.

The process 300 moves to block 315 wherein the server 150 receives the identifier or information about the refilling unit 110 from the station 105, via, for example, the scanner 115 or the processing unit 125. The server 150 queries the subscriber database 160. Information received from the subscriber database 160 includes pieces of information about individuals who have interacted with the automated dispensing system 100 previously and have created an account. Information associated with the account includes but is not limited to personal identification information, subscription information, number of refills left in the user's subscription, preferences on drink order the user may have, what orders the user has refilled their refillable units before, the type of refillable units the user has purchased, etc. In this way, the server confirms that the identifier 112 is associate with subscriber information in the subscriber database.

The process 300 from block 315 moves to block 320 where the server 150 sends a verification code to the user using contact information stored in the subscriber database 160. The verification code to the user can be sent via phone number, email, notification of an application associated with the automated dispensing system, to the user interface 155, etc.

The process 300 then moves to block 330 where the user interface 155 prompts the user to enter the verification code that was previously sent to the user at block 320. From there, the process 300 moves to decision state 340 where the server 150 determines whether the code is recognized by the server 150 as the code that was sent to the user.

If the code inputted was correct the process 300 moves to decision state 350. If the code inputted was not correct, then the process 300 moves to block 370 where the user interface 155 notifies the user that the refillable unit 110 needs to be retried.

Returning to decision state 350, the server 150 determines whether the refillable unit is associated with a subscription. If the server 150 determines that the refillable unit 110 is associated with a subscription, then the process 300 moves to block 355 wherein the server 150 checks the subscription information. If at decision state 350 the server 150 determines that the refillable unit 110 is not on a subscription, then the process 300 moves to block 365 where the user interface 155 requests a payment from the user. The process from block 365 moves to decision state 375 where the server 150 determines whether payment has been received. At decision state 375 if the server 150 determines that payment has been received then the process 300 moves to block 380 where the automated dispensing system 100 prompts the dispensing mechanism 130 to fill the refillable unit 110 with the associated beverage of the user's choice. If at decision state 375 the server 150 determines that payment has not been received then the process 300 moves to block 370 and the user interface 155 notifies the user that the refillable unit 110 needs to be retrieved.

Returning to block 355, the server checks the subscription information with the associated refillable unit 110 and the process 300 moves to decision state 360 where the server 150 determines if the subscription has any refills left. If the server 150 determines that the subscription has no refills left the process 300 moves to block 365. If the server 150 determines that the subscription has refills left then the process 300 moves to block 380.

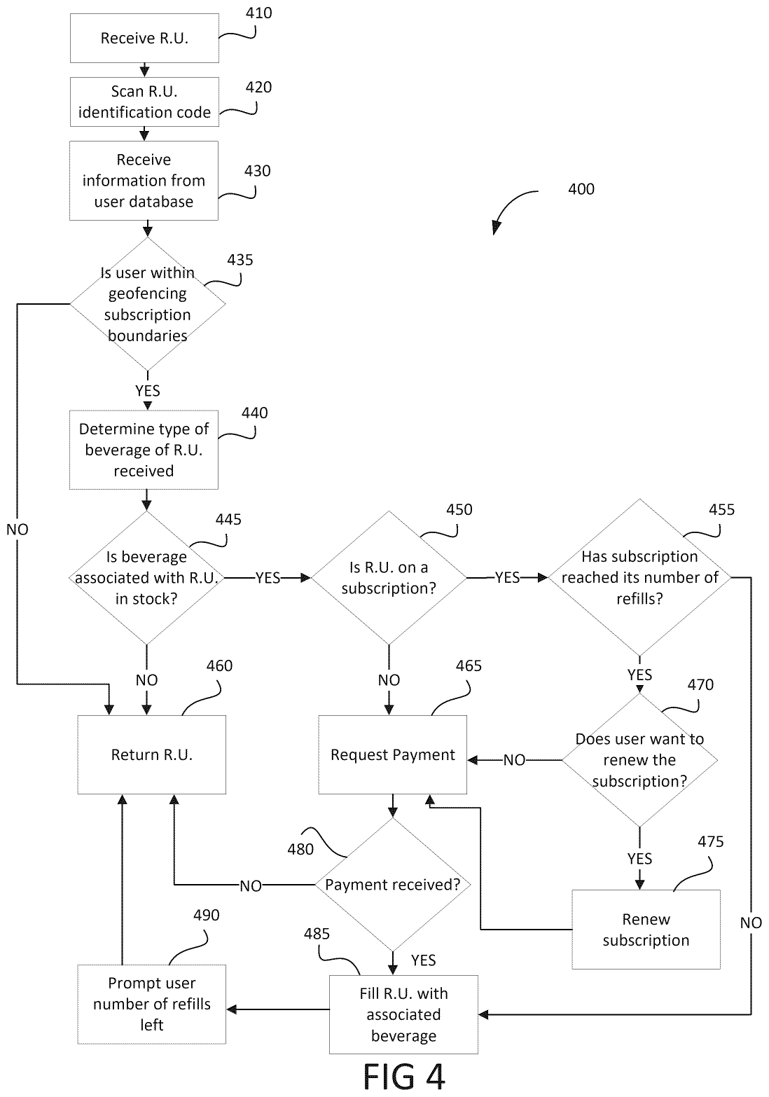

FIG. 4 is a flow chart illustrating an exemplary process for the method of using an automated dispensing system with a refillable unit 110.

A process 400 begins at block 410 wherein the automated dispensing system 100 receives a refillable unit 110. The process 400 then moves to block 420 where the scanner 115 scans the refillable unit's 110 identification code. After the identification code is scanned, the process 400 moves to block 430 where the server receives information from a subscriber database 160 regarding the refillable unit 110. These steps can be similar those described above with regard to processes 200 and 300.

The process then moves to decision state 435 where the server 150 determines whether the user is within specified geofencing boundaries of a subscription. The server 150 can receive the location of the user via the mobile computing device 180 communicating with the user interface 155, and the user interface 155 can communicate with the server. In some embodiments, the mobile computing device communicates with the station 105, which, in turn, can communicate with the server 150.

Using a geofence boundary for dispensing a beverage can indicate whether the subscribed user is at the station 105. In some embodiments, a subscriber may have a home area in which beverages are included in a subscription at a first rate, and another area in which beverages are included at a separate rate. In some embodiments, there may be a geographic area in which the subscription cannot be used. Geofencing boundaries are virtual perimeters or geographic zones that can be defined according to an existing boundary, such as a zip code, area code, municipality boundary, government jurisdiction, or based on other area. In some embodiments, the boundaries can be drawn according to other metrics. In some embodiments, each station 105 can have an individual geofence. In some embodiments, a geofence may encompass more than one station 105. In some embodiments, a station 105 may be in one or more geofences. Geofence boundaries can also be used in various applications to trigger actions or alerts when a device enters or exits the defined area. The geofencing boundaries can be determined by a specified latitude and longitude coordinates around an automated dispensing system 100. The geofencing boundaries can serve multiple functions including geofencing systems that determine when a device enters or exits a defined boundary at a specific event, or location. The geofence boundary can be associated with a subscription in the subscriber database 160.

If the server 150 determines in decision state 435 that the mobile computing device 180 is within the specified geofencing boundaries of the subscription, then the process 400 moves to block 440. In some embodiments, if the server 150 determines that the user is not within the specified geofencing boundaries of the subscription then the process 400 moves to block 460 where the automated dispensing system returns the refillable unit 110 without dispensing the beverage and the user interface 155 notifies the user to retrieve the refillable unit 110. In some embodiments, the server 150 can alter the payment parameters or the availability of beverages based on which station 105 the mobile computing device 180 is located at. In some embodiments, an association between the mobile computing device 180 and the refillable unit 110 is stored in the subscriber database 160. If the mobile computing device 180 associated with the refillable unit 110 is not within the geofence of the station 105 where the refillable unit 110 is inserted, then beverages will not be dispensed.

Returning to block 440 the server 150 determines the type of beverage that the user would like in the refillable unit 110 that the automated dispensing system 100 has received or receives a request for a beverage via the user interface 155. In some embodiments, the determination made by the server 150 can depend on a variety of factors that include the user's prior preferences, the type of container the refillable unit 110 is, as well as the temperature
outside. In some embodiments, the server 150 may make suggestions for a beverage based on information in the subscriber database 160 and the system database 170.

The process moves to decision state 445 wherein the server 150 determines whether the beverage associated with the refillable unit 110 is in stock. If the beverage is not in stock then the process 400 moves to block 460 where the automated dispensing system 100 returns the refillable unit 110 to the user. If the beverage is in stock the process 400 moves to decision state 450.

If, in decision state 450 the server 150 that the refillable unit 110 is associated with a subscription, then the process 400 moves to decision state 455. If at decision state 450 the server 150 determines that the refillable unit 110 is not on a subscription then the process 400 moves to block 465 where the user interface 155 requests a payment from the user. The process from block 465 moves to decision state 480 where the server 150 determines whether payment has been received. At decision state 480 if the server 150 determines that payment has been received then the process 400 moves to block 485 where the automated dispensing system 100 prompts the dispensing mechanism 130 to fill the refillable unit 110 with the associated beverage of the user's choice. If at decision state 480 the server 150 determines that payment has not been received, then the process 400 moves to block 460 where the automated dispensing system 100 returns the refillable unit 110 and the user interface 155 notifies the user that the refillable unit 110 needs to be retrieved.

Returning to decision state 455, the server 150 checks the subscription information with the associated refillable unit 110 to determine whether the subscription has reached its number of refills. If the server 150 determines that the subscription has reached its number of refills then the process 400 moves to decision state 470. If the server 150 has determined that the subscription has not reached its number of refills then the process 400 moves to block 485 where the automated dispensing system 100 fills the refillable unit 110 with the associated beverage. From there the process 400 moves to block 490 where the user interface 155 prompts the user the number of refills that are left. From block 490 the process moves to block 460 where the automated dispensing system 100 returns the refillable unit 110.

Returning to decision state 470, the user interface prompts the user whether they would like to renew their subscription. Based on user feedback, if the server 150 determines that the user would like to renew their subscription then the process 400 moves to block 475 where the subscription is renewed and noted within the subscriber database 160. From block 475 the process 400 moves to block 465 where the user interface 155 prompts the user for payment.

Returning to decision state 470, based on the user feedback, if the server 150 determines that the user does not want to renew their subscription then the process 400 moves to block 465.

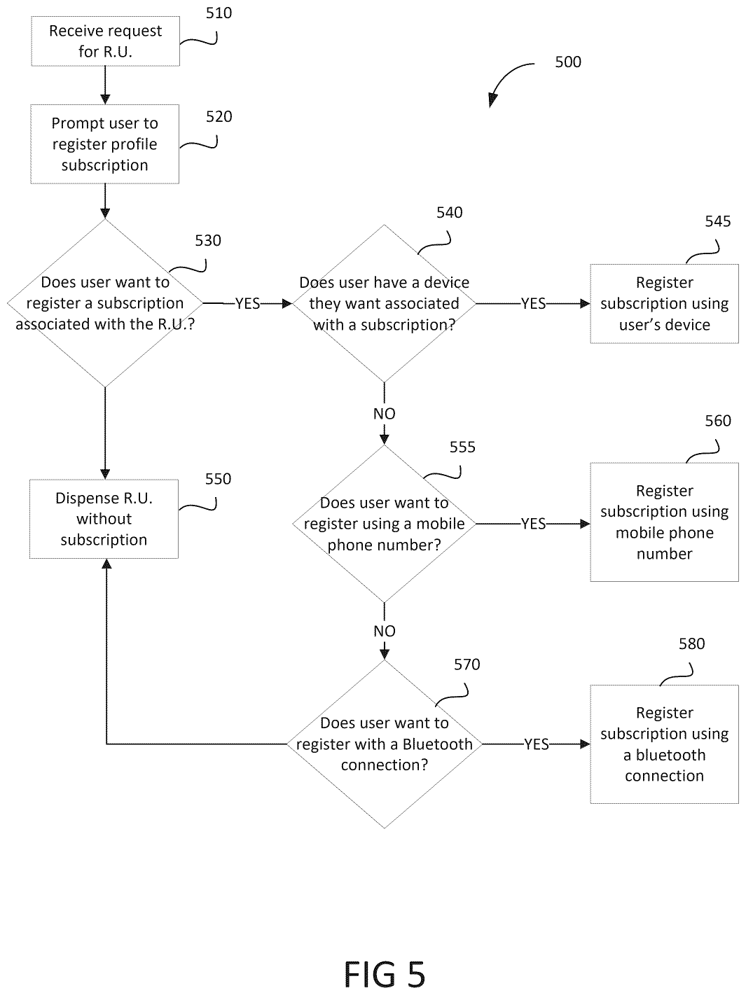

FIG. 5 is a flow chart illustrating an exemplary process for the method of using an automated dispensing system of beverages with a refillable unit 110 where the automated dispensing system 100 prompts the user via the user interface 155 to register a profile subscription.

A process 500 begins at block 510 where the automated dispensing system 100 receives a request for a refillable unit 110. The request for the refillable unit 110 can either be to purchase the refillable unit 110 from the automated dispensing system 100 or the user can also place a refillable unit 110 that they have already purchased that they would like to refill. In some embodiments, the user can request to register a user-provided refillable unit 110 with the system 100.

The process 500 then moves to block 520 where the server 150 via the user interface 155 prompts the user to register a profile subscription. The profile subscription that the user registers may include a variety of information including but not limited to a person's basic personal information such as name, age, address, email address, and phone number. The information on the profile subscription can also include drink preferences that the user inputs into the system.

The process 500 moves to decisions state 530 where the server 150 determines whether the user wants to register a subscription associated with the refillable unit 110 that they have inserted. Establishing a subscription can either be with a certain amount or number of drinks pre-paid or a subscription where the user gets charged an amount recurringly and gets a number of drink allocated with each billing cycle. If the user wants to establish a subscription, then the process 500 moves to decision state 540. If the user does not want to establish a subscription, then the process 500 moves to block 550 where the station 105 dispenses a drink that the user has selected and returns the refillable unit 110 to the user.

Returning to decision state 540 the server 150 determines whether the user would like to have a device associated with the subscription. If the user wants to set up a device with the subscription then the process 500 moves to block 545 where the user registers the subscription using a user's device. If the device is one not provided by the dispensing system 100, the server 150 via user interface 155 prompts the user to register a device profile. The device profile may include a variety of information including but not limited to the material, size, drink type, and name of the user-originated refillable unit. The system completes registration by printing an identifier 112 such as a 1D or 2D barcode or QR code, printable RFID tag, Bluetooth® device, or the like.

If the user does not want to register a device with the associated subscription then the process 500 moves to block 555 where the server 150 determines whether the user would like to register a mobile phone number. The mobile phone number registered with the device and subscription can be later used to pull up a user's profile and saved preferences. If the user wishes to register their mobile phone number with the device then the process 500 moves to block 560 where the server 150 registers the subscription using the mobile phone number provided by the user.

If the user does not want to register their subscription using a mobile phone number then the process 500 moves to decision state 570 where the server 150 prompts the user via the user interface 155 to determine whether the user would like to register their subscription via a Bluetooth connection. If the user would like to register their subscription using a Bluetooth connection then the process 500 moves to block 580 where the user is prompted to register their subscription using a Bluetooth connection.

If the user does not want to register their subscription using a Bluetooth connection then the process 500 moves from decision state 570 to block 550 where the automated dispensing system 100 dispenses the refillable unit 110 back to the user without the subscription.

The technology is operational with numerous other general purpose or special purpose computing system environments or configurations. Examples of well-known computing systems, environments, and/or configurations that may be suitable for use with the invention include, but are not limited to, personal computers, server computers, hand-held or laptop devices, multiprocessor systems, processor-based systems, programmable consumer electronics, network PCs, minicomputers, mainframe computers, distributed computing environments that include any of the above systems or devices, and the like.

As used herein, instructions refer to computer-implemented steps for processing information in the system. Instructions can be implemented in software, firmware or hardware and include any type of programmed step undertaken by components of the system.

A processor may be any conventional general purpose single- or multi-chip processor such as a Pentium® processor, a Pentium® Pro processor, a 8051 processor, a MIPS® processor, a Power PC® processor, or an Alpha® processor. In addition, the processor may be any conventional special purpose processor such as a digital signal processor or a graphics
processor. The processor typically has conventional address lines, conventional data lines, and one or more conventional control lines.

The system is comprised of various modules as discussed in detail. As can be appreciated by one of ordinary skill in the art, each of the modules comprises various sub-routines, procedures, definitional statements and macros. Each of the modules are typically separately compiled and linked into a single executable program. Therefore, the description of each of the modules is used for convenience to describe the functionality of the preferred system. Thus, the processes that are undergone by each of the modules may be arbitrarily redistributed to one of the other modules, combined together in a single module, or made available in, for example, a shareable dynamic link library.

The system may be used in connection with various operating systems such as Linux®, UNIX® or Microsoft Windows®.

The system may be written in any conventional programming language such as C, C++, BASIC, Pascal, or Java, and ran under a conventional operating system. C, C++, BASIC, Pascal, Java, and FORTRAN are industry standard programming languages for which many commercial compilers can be used to create executable code. The system may also be written using interpreted languages such as Perl, Python or Ruby.

Those of skill will further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete
gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

In one or more example embodiments, the functions and methods described may be implemented in hardware, software, or firmware executed on a processor, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

The foregoing description details certain embodiments of the systems, devices, and methods disclosed herein. It will be appreciated, however, that no matter how detailed the foregoing appears in text, the systems, devices, and methods can be practiced in many ways. As is also stated above, it should be noted that the use of particular terminology when
describing certain features or aspects of the invention should not be taken to imply that the terminology is being re-defined herein to be restricted to including any specific characteristics of the features or aspects of the technology with which that terminology is associated.

It will be appreciated by those skilled in the art that various modifications and changes may be made without departing from the scope of the described technology. Such modifications and changes are intended to fall within the scope of the embodiments. It will also be appreciated by those of skill in the art that parts included in one embodiment are interchangeable with other embodiments; one or more parts from a depicted embodiment can be included with other depicted embodiments in any combination. For example, any of the various components described herein and/or depicted in the Figures may be combined, interchanged or excluded from other embodiments.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various aspects and embodiments have been disclosed herein, other aspects and embodiments will be apparent to those skilled in the art. The various aspects and embodiments disclosed herein are for purposes of illustration and are not intended to be limiting.

In some aspects, the techniques described herein relate to an automated dispensing system including: a scanner, a beverage center, a dispensing mechanism, and a user interface configured to receive a refillable unit and automatically dispense a desired beverage selected by a user.

In some aspects, the techniques described herein relate to an automated dispensing system, wherein a user inserts a refillable unit in the automated dispensing system and selects a beverage to be filled into the refillable unit.

In some aspects, the techniques described herein relate to an automated dispensing system, wherein the user can set up a user subscription associated with the refillable unit.

In some aspects, the techniques described herein relate to an automated dispensing system, wherein when the user sets up their user subscription associated with the refillable unit, the user can also identify beverage preferences.

In some aspects, the techniques described herein relate to an automated dispensing system, wherein the beverage preferences inputted by the user include the type of beverage and any preferred additions such as a beverage temperature of the drink, additional flavors, ratio of ice to beverage.

In some aspects, the techniques described herein relate to an automated dispensing system, wherein the refillable unit has a unique computer readable identifier that the scanner scans to track the amount of beverages associated with the refillable unit or the subscription associated with the refillable unit.

In some aspects, the techniques described herein relate to an automated dispensing system, wherein the user when establishing their subscription associated with the refillable unit can input user preferences of a preferred beverage and the scanner when scanning the unique computer readable identifier automatically dispenses the drink that the user has inputted in their preference.

In some aspects, the techniques described herein relate to a method of automatically refilling a refillable unit including: scanning a refillable unit by a scanner; receiving via a server a user profile established by a user associated with the refillable unit; determining whether the user profile associated with the refillable unit has any prepaid drinks left on their account; if the user has drinks left on their account, filling the refillable unit with the associated drink of the refillable unit; if the user has no drinks left on their account, prompting the user for a payment method.

In some aspects, the techniques described herein relate to a method, wherein filling the refillable unit with the associated drink of the refillable unit includes determining from the user profile associated with the refillable unit the type of beverage the user has previously ordered with the refillable unit.

In some aspects, the techniques described herein relate to a method, wherein the type of beverage the user has previously ordered is saved on the user profile along with any preferred additions including a beverage temperature of the drink, additional flavors, ratio of ice to beverage.

In some aspects, the techniques described herein relate to a method, wherein the refillable unit has a unique computer readable identifier that the scanner scans to track the amount of beverages associated with the refillable unit or a subscription associated with the refillable unit.

In some aspects, the techniques described herein relate to a method, wherein the subscription associated with the refillable unit is established by the user and includes either a prepaid amount of drink by the user or a recurring charge for a specific amount of drinks the user can use that renews automatically.

In some aspects, the techniques described herein relate to a method, wherein determining whether the user profile has any drinks left associated with the refillable unit includes the server comparing the user subscription with the user profile associated with the refillable and compares the amount of prepaid drinks the user has paid for or whether the subscription renews automatically.

In some aspects, the techniques described herein relate to a method of automatically refilling a refillable unit including: inserting a refillable unit in an automated dispensing system; inputting user information from a user profile associated with the refillable unit; if there are prepaid drinks left on the user profile associated with the refillable unit, having the refillable unit refilled with a desired beverage previously inputted into the user profile; if there are no prepaid drinks left on the user profile associated with the refillable unit, being prompted to input a payment method and then having the refillable unit refilled with the desired beverage associated with the user profile.

In some aspects, the techniques described herein relate to a method, wherein filling the refillable unit with the associated drink of the refillable unit includes determining from the user profile associated with the refillable unit the type of beverage the user has previously ordered with the refillable unit.

In some aspects, the techniques described herein relate to a method, wherein the desired beverage the user has previously inputted is saved on the user profile along with any preferred additions including a beverage temperature of the drink, additional flavors, ratio of ice to beverage.

In some aspects, the techniques described herein relate to a method, wherein the refillable unit has a unique computer readable identifier that the scanner scans to track the amount of beverages associated with the refillable unit or a subscription associated with the refillable unit.

In some aspects, the techniques described herein relate to an automated dispensing system, wherein the user, when establishing their subscription, can register using a mobile phone number or Bluetooth connection and later connect a refillable unit to their profile.

In some aspects, the techniques described herein relate to a method, wherein the subscription associated with the refillable unit is established by the user and includes either a prepaid amount of drink by the user or a recurring charge for a specific amount of drinks the user can use that renews automatically.

In some aspects, the techniques described herein relate to a method of dispensing a one-time-use unit including: receiving via telephone number or Bluetooth connection a user profile established by a user; determining that the user wants a one-time-use unit via the user interface, determining whether the user profile associated with the refillable unit has any prepaid drinks left on their account; if the user has drinks left on their account, dispensing the one-time-use unit and filling the unit with the requested drink; if the user has no drinks left on their account, prompting the user for a payment method.

In some aspects, the techniques described herein relate to a method, wherein determining whether the user profile has any drinks left associated with the refillable unit includes the server comparing the user subscription with the user profile associated with the refillable and compares the amount of prepaid drinks the user has paid for or whether the subscription renews automatically.

In some aspects, the techniques described herein relate to a method, wherein registering a user-originated refillable unit includes storing user-input data about the unit's composition and associating it with the user's subscription profile.

What is claimed is:

1. An automated dispensing system comprising:
a scanner,
a dispensing mechanism, and
a user interface configured to:
receive a refillable unit;
using the scanner, identify an electronic identifier of the refillable unit, wherein the electronic identifier is within electronic range of the dispensing mechanism;
verify the electronic identifier; and
in response to a positive verification of the electronic identifier, automatically dispense a refill selected by a user.

2. The automated dispensing system of claim 1, wherein a user inserts a refillable unit in the automated dispensing system and selects a beverage to be filled into the refillable unit.

3. The automated dispensing system of claim 1, wherein the refillable unit is associated with a user subscription, and wherein the user subscription provides:
active payment data for a user, user preference selections, wherein user preference selections may include beverage temperature of the refill, additional flavors, ratio of ice to beverage user account data, subscription status data, and/or metadata associated with the user subscription.

4. The automated dispensing system of claim 3, wherein when the user interface is further configured to upon determining that the electronic identifier does not correspond to a valid user subscription, decline a request for dispensing a desired refill.

5. The automated dispensing system of claim 1, wherein the dispensing system dispenses at least one of the following into the refillable unit:
a cosmetic substance,
a food substance,
a beverage, or
an electronic device.

6. The automated dispensing system of claim 1, wherein the scanner maintains a count of refills associated with the refillable unit, and wherein the user interface displays an error in response to a refill request if the count of refills passes a refill threshold.

7. The automated dispensing system of claim 6, wherein the user when establishing their subscription associated with the refillable unit can input user preferences of a preferred beverage and the scanner when scanning the electronic identifier automatically dispenses a requested refill preference.

8. The automated dispensing system of claim 1, wherein the dispensing mechanism is further configured to dispense an attachable electronic identifier configured to be affixed to the removable unit.

9. The automated dispensing system of claim 8, wherein the user interface is further configured to receive one or more characteristics of the refillable unit, and to associate the one or more characteristics with the attachable electronic identifier.

10. A method for an automated dispensing system comprising:
receiving a refillable unit;
receiving, at a scanner, an electronic signal of an embedded electronic identifier of the refillable unit, wherein the electronic signal identifies a user profile associated with the refillable unit;
validating, via a server, the user profile, wherein validating the user profile comprises determining whether the user profile is authorized for a prepaid refill;
upon determining authorization for the prepaid refill, refilling the refillable unit;
upon determining no prepaid refills remain in connection with the user profile, prompting a user for a payment method.

11. The method of claim 10, wherein refilling the refillable unit comprises:
determining a previous refill of the user profile; and
confirming, via a user interface, whether the previous refill preference should be repeated, wherein a previous refill preference may include a refill temperature, additional flavors, or ice ratio.

12. The method of claim 10, wherein upon processing data from the user profile, a user interface provides a prompt to a user that suggests a new refill product the user may prefer based on previous selections.

13. The method of claim 10, wherein the scanner maintains a count of refills associated with the refillable unit, and wherein a user interface displays an error in response to a refill request if the count of refills passes a refill threshold.

14. The method of claim 10, wherein the refillable unit is associated with a prepaid refill value or a recurring subscription charge for a given refill count.

15. A method of automatically refilling a refillable unit comprising:
receiving a refillable unit in an automated dispensing system, wherein the refillable unit is associated with an electronic identifier;
inputting user information from a user profile associated with the refillable unit;
determining a prepaid refill remains;
upon determining a prepaid refill remains, refilling the refillable unit refilled with desired contents based on the user profile; and
if there are no prepaid refills left on the user profile associated with the refillable unit, being prompted to input a payment method and then having the refillable unit refilled with a desired refill associated with the user profile.

16. The method of claim 15, further comprising, upon determining that the electronic identifier does not correspond to a valid user subscription, declining a request for dispensing a desired refill.

17. The method of claim 15, wherein the desired refill the user has previously inputted is saved on the user profile along with any preferred additions including a refill temperature, additional flavor, or ice ratio.

18. The method of claim 15, wherein the electronic identifier maintains a count of refills associated with the refillable unit.

19. The method of claim 15, wherein the refillable unit is associated with a prepaid refill value or a recurring subscription charge for a given refill count.

20. The method of claim 15 further comprising, dispensing an attachable electronic identifier configured to be affixed to the removable unit.
